(19) United States
(12) Patent Application Publication
(10) Pub. No.: US 2026/0341846 A1
(43) Pub. Date: Oct. 29, 2026

(54) BATTERY ARRAY CELL SUPPORTING STRUCTURES FOR TRACTION BATTERY PACKS

(71) Applicant: FORD GLOBAL TECHNOLOGIES, LLC, Dearborn, MI (US)

(72) Inventors: Sangyeon Kim, Northville, MI (US); Pradeep Elumalai, Northville, MI (US)

(21) Appl. No.: 19/189,505

(22) Filed: Apr. 25, 2025

(51) Int. Cl. H01M 10/658; B60L 50/64; H01M 50/211; H01M 50/289

(52) U.S. Cl. CPC H01M 10/658; B60L 50/64; H01M 50/211; H01M 50/289; H01M 2220/20

(57) ABSTRACT

Battery array designs are provided for use within a traction battery pack. An exemplary battery array may include an array housing and a cell stack housed inside the array housing. The cell stack may include a plurality of battery cells, an upper beam, and a lower beam. The upper beam and the lower beam may cooperate to establish a support structure for mechanical stabilizing and supporting the battery cells within the cell stack. The cell stack may further include a thermal barrier assembly having a design that is capable of thermally and/or structurally interfacing with the upper beam, the lower beam, and the array housing.

### TECHNICAL FIELD

This disclosure relates generally to electrified vehicle traction battery packs, and more particularly to battery cell supporting structures for use within battery arrays of traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an array housing, a thermal barrier assembly housed inside the array housing, a first upper beam extending between a thermal fin of the thermal barrier assembly and a top cover of the array housing, and a first lower beam extending between the thermal fin and a bottom cover of the array housing.

In a further non-limiting embodiment of the foregoing battery array, an upper fin portion of the thermal fin is fixedly secured to the top cover by an adhesive.

In a further non-limiting embodiment of either of the foregoing battery arrays, a lower fin portion of the thermal fin is fixedly secured to the bottom cover by an adhesive.

In a further non-limiting embodiment of any of the foregoing battery arrays, the thermal barrier assembly separates a first compartment where a first cell packet resides from a second compartment where a second cell packet resides.

In a further non-limiting embodiment of any of the foregoing battery arrays, the first compartment and the second compartment establish separate coolant flow passages inside the battery array.

In a further non-limiting embodiment of any of the foregoing battery arrays, the first upper beam is accommodated within a first notch of the thermal fin, and the first lower beam is accommodated within a second notch of the thermal fin.

In a further non-limiting embodiment of any of the foregoing battery arrays, the first lower beam includes a groove that is sized to receive a portion of the thermal fin.

In a further non-limiting embodiment of any of the foregoing battery arrays, an adhesive is disposed between the groove and the portion of the thermal fin.

In a further non-limiting embodiment of any of the foregoing battery arrays, an adhesive is disposed between a plurality of battery cells of the battery array and the first lower beam.

In a further non-limiting embodiment of any of the foregoing battery arrays, the first upper beam is fixedly secured to the top cover by a first portion of an adhesive, and the first lower beam is fixedly secured to the bottom cover by a second portion of the adhesive.

In a further non-limiting embodiment of any of the foregoing battery arrays, a second upper beam extends between the thermal fin of the thermal barrier assembly and the top cover of the array housing, and a second lower beam extends between the thermal fin and the bottom cover of the array housing.

In a further non-limiting embodiment of any of the foregoing battery arrays, the thermal fin is C-shaped.

In a further non-limiting embodiment of any of the foregoing battery arrays, the thermal fin is I-shaped.

A battery array for a traction battery pack according to another exemplary aspect of the present disclosure includes, among other things, an array housing including a top cover and a bottom cover. A cell stack is positioned inside the array housing and includes a plurality of battery cells, a first upper beam positioned between the top cover and the plurality of battery cells, and a first lower beam positioned between the bottom cover and the plurality of battery cells. The first upper beam and the first lower beam establish a support structure for mechanically supporting the plurality of battery cells.

In a further non-limiting embodiment of the foregoing battery array, the cell stack includes a thermal barrier assembly disposed between a first portion of the plurality of battery cells and a second portion of the plurality of battery cells.

In a further non-limiting embodiment of either of the foregoing battery arrays, the first upper beam extends between the top cover and a thermal fin of the thermal barrier assembly, and the first lower beam extends between the bottom cover and the thermal fin.

In a further non-limiting embodiment of any of the foregoing battery arrays, the first upper beam is fixedly secured to the top cover by a first portion of an adhesive, and the first lower beam is fixedly secured to the bottom cover by a second portion of the adhesive.

In a further non-limiting embodiment of any of the foregoing battery arrays, an upper fin portion of the thermal fin is fixedly secured to the top cover by a first portion of an adhesive, and a lower fin portion of the thermal fin is fixedly secured to the bottom cover by a second portion of the adhesive.

In a further non-limiting embodiment of any of the foregoing battery arrays, the first lower beam includes a groove that is sized to receive a portion of the thermal fin.

In a further non-limiting embodiment of any of the foregoing battery arrays, an adhesive is disposed between the groove and the portion of the thermal fin.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of an exemplary battery array of a traction battery pack.

FIG. 3 is a top perspective view of a cell stack of the battery array of FIG. 2.

FIG. 4 is a bottom perspective view of the cell stack of FIG. 3.

FIG. 5 is a cross-sectional view through section 5-5 of FIG. 2.

FIG. 6 is a cross-sectional view through section 6-6 of FIG. 2.

FIG. 7 illustrates an exemplary thermal fin for a thermal barrier assembly.

FIG. 8 illustrates another exemplary thermal fin for a thermal barrier assembly.

### DETAILED DESCRIPTION

This disclosure details battery array designs for use within a traction battery pack. An exemplary battery array may include an array housing and a cell stack housed inside the array housing. The cell stack may include a plurality of battery cells, an upper beam, and a lower beam. The upper beam and the lower beam may cooperate to establish a support structure for mechanical stabilizing and supporting the battery cells within the cell stack. The cell stack may further include a thermal barrier assembly having a design that is capable of thermally and/or structurally interfacing with the upper beam, the lower beam, and the array housing. These and other features are discussed in greater detail in the following paragraphs of this detailed description.

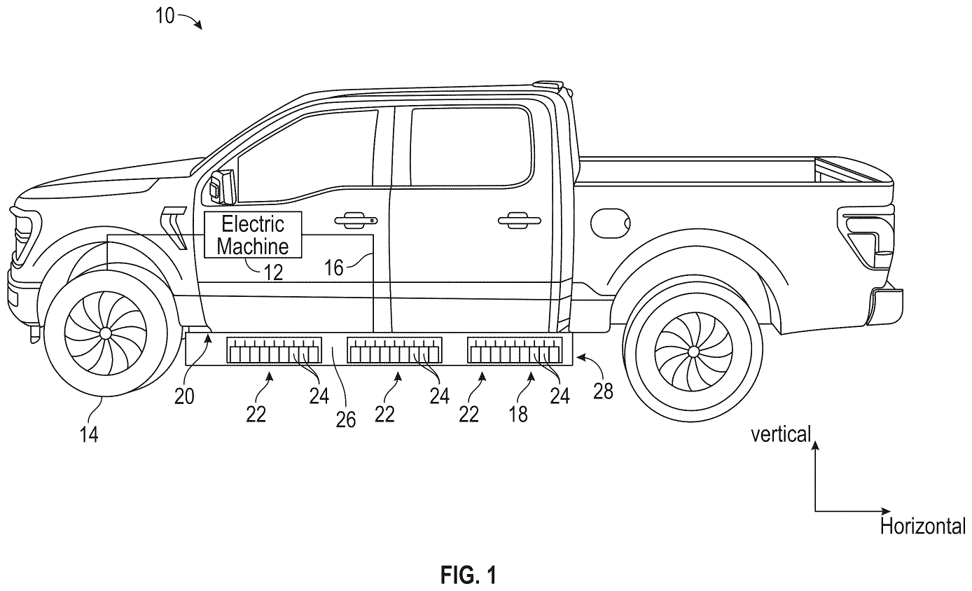

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

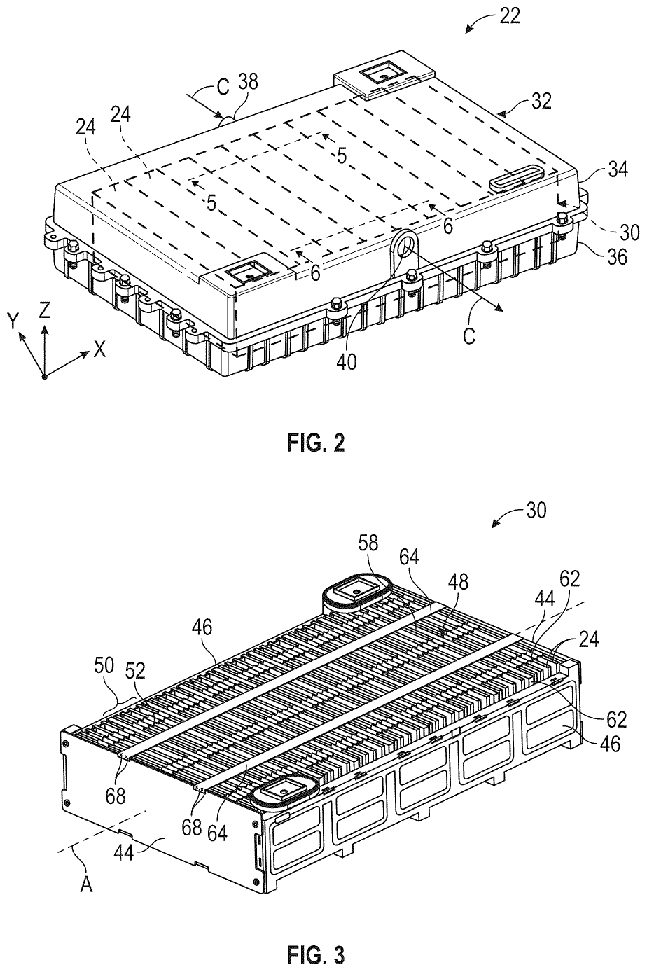

FIG. 2 illustrates features associated with a battery array 22 of a traction battery pack. For example, the traction battery pack 18 of the electrified vehicle 10 of FIG. 1 could include one or more battery arrays having a design substantially similar to that of the battery array 22 shown in FIG. 2.

The battery array 22 may include one or more cell stacks 30 housed inside an array housing 32. The array housing 32 may include a top cover 34 and a bottom cover 36, which may both include tray-like structures. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are generally referenced relative to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 could vary within the scope of this disclosure.

The cell stack 30 may include a plurality of battery cells 24. Thermal energy levels of the battery cells 24 of the battery array 22 can increase as the electrified vehicle 10 is operated. A thermal management system can therefore be employed for managing the thermal energy levels of the battery cells 24 of the battery array 22. The thermal management system may be configured to route a coolant C through the interior of the array housing 32 of the battery array 22 in order to manage the thermal energy levels of the battery array 22 by, for example, using the coolant C to take on and carry away thermal energy from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22.

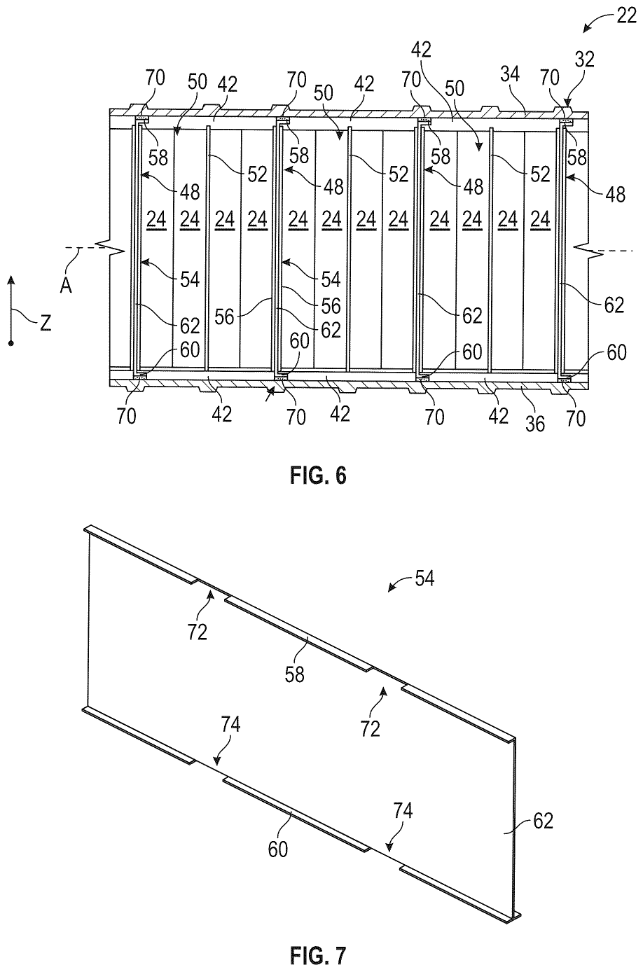

The thermal management system can deliver the coolant C to the interior of the battery array 22 through an inlet 38 of the array housing 32. The coolant C can fill one or more open areas (see, e.g., compartments 42, which are best shown in FIGS. 5-6) inside the battery array 22 such that the battery cells 24 are directly contacted by the coolant C. The coolant C can take on thermal energy from the battery cells 24 for managing the thermal energy levels of the battery array 22. The coolant C may exit the battery array 22 through an outlet 40 of the array housing 32. In an embodiment, both the inlet 38 and the outlet 40 are provided through the top cover 34 of the array housing 32. However, other inlet 38 and/or outlet 40 locations are contemplated within the scope of this disclosure.

The coolant C exiting through the outlet 40 can move to a thermal energy exchange device (not shown), such as a heat exchanger, for example, where thermal energy can be transferred from the coolant C to atmosphere. A pump (not shown) can be operated to selectively circulate the coolant C between the battery array 22 and the thermal energy exchange device and then back to the battery array 22 as part of a closed-loop system.

The coolant C circulated in the immersion thermal management system may be a dielectric fluid or another type of non-electrically conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, thermal conductivity, etc.) may vary depending on the environment the battery array 22 is to be deployed.

In another embodiment, the thermal management system is a conventional cold plate system in which the coolant C, such as ethylene glycol, is circulated through a cold plate (not shown) in order to thermally manage heat generated by the battery cells 24. The teachings of this disclosure are therefore not limited to battery arrays having immersion thermal management systems. The battery cells 24 are not immersed in the coolant C in the cold plate type of thermal management system.

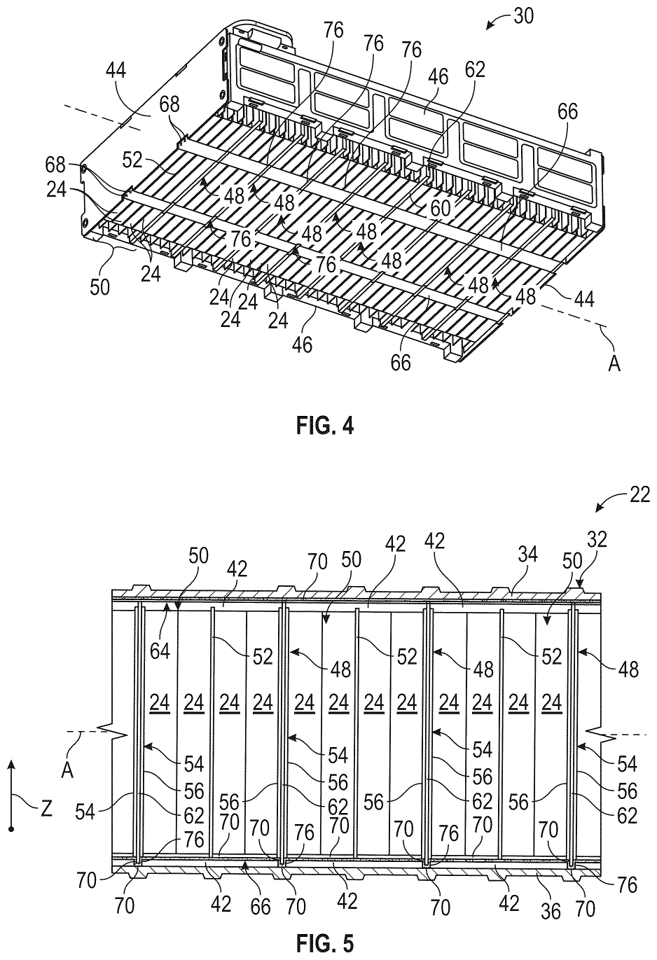

FIGS. 3-6 illustrate various details associated with the cell stack 30 of the battery array 22 of FIG. 2 and its relationship to the array housing 32. The battery cells 24 of the cell stack 30 may be arranged to extend longitudinally between opposing end plates 44 and laterally between opposing side plates 46. The battery cells 24 may be arranged together along a cell stack axis A between the opposing end plates 44. Although a single cell stack 30 having a specific number of battery cells 24 is illustrated in the figures of this disclosure, the battery array 22 could include any number of cell stacks 30, with each cell stack 30 having any number of individual battery cells 24.

A plurality of thermal barrier assemblies 48 can be interspersed along the cell stack axis A between adjacent battery cells 24 of the cell stack 30. The thermal barrier assemblies 48 may be configured to interface with the array housing 32 for compartmentalizing the battery array 22 into multiple of the compartments 42. Each compartment 42 may establish a dedicated coolant flow passage for directing the coolant C through the battery array 22 as part of the immersion thermal management system described above.

Each compartment 42 may house a cell packet 50, which is a subgrouping of the plurality of battery cells 24 of the cell stack 30. Each cell packet 50 may be disposed between adjacent pairs of the thermal barrier assemblies 48. In an embodiment, each cell packet 50 includes four battery cells 24 and one cell expansion pad 52 that is sandwiched between subsets of two of the four battery cells 24 that make up the cell packet 50. However, other configurations are contemplated within the scope of this disclosure, and it should be evident to those having the benefit of this disclosure that the cell stack 30 could include any amount and arrangement of battery cells 24, thermal barrier assemblies 48, cell packets 50, cell expansion pads 52, etc.

The thermal barrier assemblies 48 may include various designs/configurations within the scope of this disclosure. In an embodiment, each thermal barrier assembly 48 may include a thermal fin 54, which may be made of a metallic material such as aluminum, for example, that is flanked by additional layers 56 (best seen in FIGS. 5-6), such as foam and/or thermal resistance material layers, for example, as part of a multi-layered sandwich structure. The thermal barrier assemblies 48 may therefore include metallic materials, high temperature resistance thermoplastic or thermoset composites, aerogel materials, mica materials, foam materials, or any combination of these and/or other materials.

Each thermal fin 54 may include an upper fin portion 58, a lower fin portion 60, and a mid-fin portion 62 extending between the upper fin portion 58 and the lower fin portion 60. The upper fin portion 58 and the lower fin portion 60 may each be configured as a flange that extends at a transverse angle (e.g., about perpendicular) from the mid-fin portion 62. The upper fin portion 58 may be configured to interface with the top cover 34 of the array housing 32 (see FIG. 6) or an intermediate structure (e.g., the upper beam(s) 64 described below, see FIG. 5), and the lower fin portion 60 may be configured to interface with the bottom cover 36 of the array housing 32 (see FIG. 6) or an intermediate structure (e.g., the lower beam(s) 66 described below, see FIG. 5). The mid-fin portion 62 may be positioned axially between adjacent battery cells 24 of adjacent cell packets 50 of the cell stack 30.

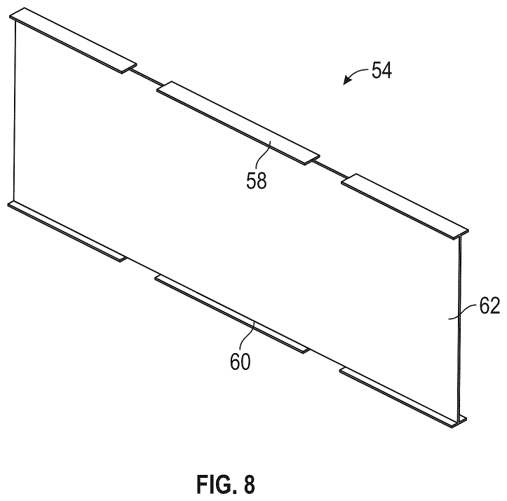

In an embodiment, each thermal fin 54 includes a C-shaped design (see FIG. 7) or an I-shaped design (see FIG. 8). However, other shapes are contemplated within the scope of this disclosure.

The upper fin portions 58 of the thermal fins 54 may extend above the battery cells 24, and the lower fin portions 60 of the thermal fins 54 may extend below the battery cells 24. The thermal fins 54 can therefore aid in establishing the compartments 42. Should, for example, a battery thermal event occur in one of the compartments 42, the thermal barrier assemblies 48 can reduce or even prevent thermal energy associated with the thermal event from moving from cell-to-cell, compartment-to-compartment, and/or cell stack-to-cell stack, thereby inhibiting the transfer of thermal energy inside the battery array 22. Moreover, due to the increased contact with the array housing 32 achieved by the upper fin portions 58 and the lower fin portion 60, the thermal barrier assemblies 48 can provide increased thermal transfer mitigation performance by directing a greater amount of heat transfer into the array housing 32.

The cell stack 30 may additionally at least one upper beam 64 and at least one lower beam 66. The upper beam(s) 64 and the lower beam(s) 66 can cooperate together to provide a support structure for mechanically stabilizing and supporting the battery cells 24 in a vertical or Z-axis direction, thereby increasing the mechanical strength of the cell stack 30. In an exemplary embodiment, the cell stack 30 includes a pair of upper beams 64 and a pair of lower beams 66. However, other configurations are contemplated within the scope of this disclosure.

The upper beam(s) 64 and the lower beam(s) 66 may be made of a metallic material. In an embodiment, the upper beam(s) 64 and the lower beam(s) 66 are aluminum beams. However, other materials are contemplated within the scope of this disclosure.

Each upper beam 64 may be positioned to extend over top of the battery cells 24, the thermal barrier assemblies 48, and the cell expansion pads 52 of the cell stack 30. The upper beams 64 may extend longitudinally between the opposing end plates 44. The upper beams 64 may be fastened to the end plates 44, such as by one or more laser welds 68, for example. Each upper beam 64 may include a lateral dimension (e.g., in the transverse direction extending between the side plates 46) that is smaller than the overall lateral dimensions of the battery cells 24.

Each lower beam 66 may be positioned to extend beneath the battery cells 24, the thermal barrier assemblies 48, and the cell expansion pads 52 of the cell stack 30. The lower beams 66 may extend longitudinally between the opposing end plates 44. The lower beams 66 may be fastened to the end plates 44, such as by one or more additional laser welds 68, for example. Each lower beam 66 may include a lateral dimension (e.g., in the transverse direction extending between the side plates 46) that is smaller than the lateral dimensions of the battery cells 24.

The upper fin portion 58 of each thermal fin 54 may include one or more notches 72, and the lower fin portion 60 of each thermal fin 54 may include one or more additional notches 74 (see, e.g., FIG. 7). Each notch 72 may be sized to receive one of the upper beams 64, and each notch 74 may be sized to receive one of the lower beams 66.

An adhesive 70 (see FIG. 5) may be utilized to secure the upper beam(s) 64 to the top cover 34 of the array housing 32 and further to secure the lower beam(s) 66 to the bottom cover 36 of the array housing 32. An additional portion of the adhesive 70 may be utilized to secure the lower beams 66 to bottom surfaces of the battery cells 24. The adhesive 70 may be a structural adhesive, such as an epoxy based adhesive or a urethane based adhesive, for example. However, other types of adhesives are contemplated within the scope of this disclosure.

The mid-fin portion 62 of each thermal fin 54 may be received within a groove 76 formed in the lower beam 66 (see FIG. 5). An additional portion of the adhesive 70 may be applied within the grooves 76 for fixedly securing the thermal fins 54 directly to the lower beam(s) 66.

Additional portions of the adhesive 70 may be utilized to secure portions of the thermal fins 54 directly to the array housing 32. For example, in the areas of the cell stack 30 that exclude the upper beam(s) 64 and the lower beam(s) 66 (see, e.g., FIG. 6), the upper fin portions 58 of the thermal fins 54 may be fixedly secured to the top cover 34 by the adhesive 70 and the lower fin portions 60 of the thermal fins 54 may be fixedly secured to the bottom cover 36 by the adhesive 70 to structurally integrate the battery array 22, thereby increasing its rigidity/stiffness.

The exemplary battery arrays of this disclosure may include upper and lower beams that cooperate to provide support structures for supporting battery cells within a cell stack. The proposed designs provide increased mechanical stability and thermal transfer mitigation performance while facilitating a more simplified battery array assembly.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery array for a battery pack, comprising:
an array housing;
a thermal barrier assembly housed inside the array housing;
a first upper beam extending between a thermal fin of the thermal barrier assembly and a top cover of the array housing; and
a first lower beam extending between the thermal fin and a bottom cover of the array housing.

2. The battery array as recited in claim 1, wherein an upper fin portion of the thermal fin is fixedly secured to the top cover by an adhesive.

3. The battery array as recited in claim 1, wherein a lower fin portion of the thermal fin is fixedly secured to the bottom cover by an adhesive.

4. The battery array as recited in claim 1, wherein the thermal barrier assembly separates a first compartment where a first cell packet resides from a second compartment where a second cell packet resides.

5. The battery array as recited in claim 4, wherein the first compartment and the second compartment establish separate coolant flow passages inside the battery array.

6. The battery array as recited in claim 1, wherein the first upper beam is accommodated within a first notch of the thermal fin, and the first lower beam is accommodated within a second notch of the thermal fin.

7. The battery array as recited in claim 1, wherein the first lower beam includes a groove that is sized to receive a portion of the thermal fin.

8. The battery array as recited in claim 7, comprising an adhesive disposed between the groove and the portion of the thermal fin.

9. The battery array as recited in claim 1, comprising an adhesive disposed between a plurality of battery cells of the battery array and the first lower beam.

10. The battery array as recited in claim 1, wherein the first upper beam is fixedly secured to the top cover by a first portion of an adhesive, and the first lower beam is fixedly secured to the bottom cover by a second portion of the adhesive.

11. The battery array as recited in claim 1, further comprising:
a second upper beam extending between the thermal fin of the thermal barrier assembly and the top cover of the array housing; and
a second lower beam extending between the thermal fin and the bottom cover of the array housing.

12. The battery array as recited in claim 1, wherein the thermal fin is C-shaped.

13. The battery array as recited in claim 1, wherein the thermal fin is I-shaped.

14. A battery array for a battery pack, comprising:
an array housing including a top cover and a bottom cover; and
a cell stack positioned inside the array housing and including a plurality of battery cells, a first upper beam positioned between the top cover and the plurality of battery cells, and a first lower beam positioned between the bottom cover and the plurality of battery cells,
wherein the first upper beam and the first lower beam establish a support structure for mechanically supporting the plurality of battery cells.

15. The battery array as recited in claim 14, wherein the cell stack includes a thermal barrier assembly disposed between a first portion of the plurality of battery cells and a second portion of the plurality of battery cells.

16. The battery array as recited in claim 15, wherein the first upper beam extends between the top cover and a thermal fin of the thermal barrier assembly, and the first lower beam extends between the bottom cover and the thermal fin.

17. The battery array as recited in claim 16, wherein the first upper beam is fixedly secured to the top cover by a first portion of an adhesive, and the first lower beam is fixedly secured to the bottom cover by a second portion of the adhesive.

18. The battery array as recited in claim 16, wherein an upper fin portion of the thermal fin is fixedly secured to the top cover by a first portion of an adhesive, and a lower fin portion of the thermal fin is fixedly secured to the bottom cover by a second portion of the adhesive.

19. The battery array as recited in claim 16, wherein the first lower beam includes a groove that is sized to receive a portion of the thermal fin.

20. The battery array as recited in claim 19, comprising an adhesive disposed between the groove and the portion of the thermal fin.
